(19) United States
(12) Patent Application Publication
(10) Pub. No.: US 2025/0171666 A1
(43) Pub. Date: May 29, 2025

(54) EPOXY ADHESIVE AND METHOD OF USE AND PREPARATION THEREOF

(71) Applicant: The Hong Kong University of Science and Technology, Hong Kong (CN)

(72) Inventors: Jinglei YANG, Hong Kong (CN); Ying ZHAO, Hong Kong (CN); Cho Sin Nicole CHAN, Hong Kong (CN)

(21) Appl. No.: 18/961,587

(22) Filed: Nov. 27, 2024

Related U.S. Application Data
(60) Provisional application No. 63/602,671, filed on Nov. 27, 2023.

(51) Int. Cl. C09J 163/00; C09J 5/06; C09J 11/08

(52) U.S. Cl. CPC C09J 163/00; C09J 5/06; C09J 11/08

(57) ABSTRACT

A one-part adhesive composition useful for sealing threaded articles, wherein the one-part adhesive composition includes a plurality of microcapsules and a dispersion matrix, wherein each of the plurality of microcapsules comprise a core and a shell at least partially enclosing the core, wherein the core includes a polyamine and the shell comprises a crosslinked polyurea; and the dispersion matrix comprises an epoxy resin; a method of use thereof; and products thereof.

### CROSS-REFERENCE TO RELATED APPLICATIONS

The present application claims priority from U.S. Provisional Patent Application No. 63/602,671, filed on Nov. 27, 2023, which is hereby incorporated by reference in its entirety.

### TECHNICAL FIELD

The present disclosure relates to a one-part adhesive composition useful for tightening and sealing threaded articles, a method of use thereof, and products thereof.

### BACKGROUND

Threaded assemblies play a pivotal role in the construction, installation, and repair of machinery, acting as essential detachable elements for the sealing and protection of substrates. The predominant factors leading to the failure of these assemblies are tension relaxation and self-loosening. Current solutions, such as adhesive bonding and mechanical fastening—encompassing thread-locking compounds, thread sealants, screws and nuts, studs and nuts, and self-tapping screws—present certain limitations. These challenges are primarily associated with labor intensity, the necessity for on-site mixing, and material wastage.

The prevalent use of liquid anaerobic adhesives in mechanical assembly is increasingly incompatible with the demands of modern, automated production lines. These adhesives, which require immediate pre-use application, are inefficient, prone to dripping, and often result in both workpiece contamination and material waste. The introduction of pre-coated anaerobic adhesives, developed in the 1980s, has provided a solution to these issues. These adhesives allow for advanced application on fasteners, facilitating immediate use post-application or after centralized storage. This advancement eliminates the drawbacks associated with traditional liquid adhesives, such as dripping and the inefficiency of on-site operation.

Currently, the market is dominated by the two-component water-based acrylate type adhesives. These consist of an acrylate monomer (Component A) and a microencapsulated initiator (Component B). When mixed and applied to threads, these components dry to form a reactive adhesive film. During assembly, the initiator is released upon microcapsule rupture, initiating the polymerization of the acrylate monomer to fill gaps and prevent loosening. Despite their widespread use in brands like Loctite® 204 and Huitian® 2041, two-component pre-coated anaerobic adhesives are not without limitations. Manual mixing—often necessitated by equipment constraints—can lead to inconsistent mixtures, impacting fastening quality and posing risks to assembled products. Additionally, these adhesives have a limited room-temperature shelf-life post-mixing (generally within 6 hours), which can result in waste and inconvenience. Furthermore, conventional water-based thread-locking adhesives contain hydrophilic materials that are prone to moisture absorption post-application, potentially compromising curing strength and effectiveness.

Epoxy represents a kind of superior adhesive, thanks to their superiorities including tunable mechanical properties, excellent thermal stability and chemical resistance, high electrical insulating properties, good bonding characteristics, etc. It is widely used in adhesives, coatings, sealants, molding compounds and other fields, involving electronics, industry, aviation and other industries. Compared to amine hardeners which are susceptible to chemical attack and pose more environmental risk, epoxy resin is more readily microencapsulated.

Advancements in adhesive technologies have seen the development of solvent-based one-part adhesives with epoxy microcapsules dispersed in amine hardeners (CN104893635A and CN111518500A), allowing for long-term pre-coating. However, these do not fully address the challenges posed by amine hardeners. Patents like JP 5543879B2 introduce a one-part epoxy adhesive with microencapsulated hardener as the latent curing agent. However, the core hardener is based on imidazole chemistry, and the core is in solid form, which may prevent its uniform distribution during core release. Additionally, the significant market segment of hardeners—including aliphatic, aromatic, and polyether amines—has not seen development in microcapsule-based one-part adhesive formulations.

Another critical concern with conventional thread-locking adhesives is their reliance on volatile solvents for film formation, raising environmental concerns. The industry has yet to see the development of a solvent-free one-part adhesive that could serve as an environmentally friendly thread-locking solution.

Epoxy/amine systems are renowned for their adaptability, mechanical robustness, and resistance to harsh environmental conditions, such as thermal shock and chemical attack. Epoxy resin is relatively stable and can be readily microencapsulated. However, amine hardeners are not only more susceptible to chemical degradation when exposed to the environment but also pose more environmental hazards, which imposes challenges to their use in epoxy/amine systems.

There thus exists a need for improved one-part adhesives that address or overcome at least some of the disadvantages described above. This work introduces an innovative approach that leverages a solvent-free one-part epoxy adhesive incorporated with amine microcapsules to fasten the threaded assemblies. This unique adhesive can be pre-coated to the threads, initiating the curing and bonding process only when the threads are assembled. The exertion of mechanical pressure triggers the rupture of the amine microcapsules, thereby triggering the polymerization process. This method harnesses the robustness of epoxy in a more efficient and user-friendly manner. The design aims to circumvent the drawbacks of existing methods, providing a superior alternative that enhances both the practicality and effectiveness of threaded assembly maintenance and repair.

### SUMMARY

Provided herein is a one-part adhesive composition that integrates microencapsulated amines dispersed within an epoxy matrix as thread-locking adhesive.

In a first aspect, provided herein is a one-part adhesive composition comprising a plurality of microcapsules and a dispersion matrix, wherein each of the plurality of microcapsules comprise a core and a shell at least partially enclosing the core, wherein the core comprises a polyamine and the shell comprises a crosslinked polyurea; and the dispersion matrix comprises an epoxy resin.

In certain embodiments, the plurality of microcapsules have an average diameter of 10-300 μm.

In certain embodiments, the polyamine comprises a polyalkylamine, a polyetheramine, a polyarylamine, or a mixture thereof.

In certain embodiments, the polyamine comprises triethylenetetramine (TETA), tetraethylenepentamine (TEPA), a polyoxypropylenetriamine represented by:

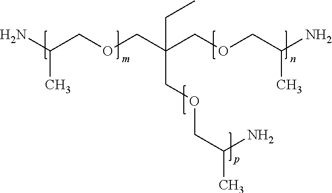

wherein m+n+p is 5-6, or a mixture thereof.

In certain embodiments, the crosslinked polyurea comprises the polyamine crosslinked with a diisocyanate, a polyisocyanate, or a mixture thereof.

In certain embodiments, the crosslinked polyurea comprises the polyamine crosslinked with 4,4′-dicyclohexylmethane diisocyanate.

In certain embodiments, the polyamine comprises TETA, TEPA, or TEPA and the polyoxypropylenetriamine.

In certain embodiments, the polyamine comprises TEPA and the polyoxypropylenetriamine, wherein the molar ratio of amines in the TEPA to the polyoxypropylenetriamine is 1:3 to 3:1, respectively.

In certain embodiments, the epoxy resin comprises a bisphenol-A type epoxy resin, a bisphenol-f type epoxy resin, a bisphenol-s epoxy resin, a linear phenolic epoxy resin, a cycloaliphatic epoxy resin, a glycidyl ester type epoxy resin, a glycidyl ether resin, a glycidyl amine epoxy resin, a halogenated epoxy resin, or a mixture thereof.

In certain embodiments, the epoxy resin comprises a bisphenol-A type epoxy resin and a bisphenol-f type epoxy resin.

In certain embodiments, the polyamine comprises triethylenetetramine (TETA), tetraethylenepentamine (TEPA), a polyoxypropylenetriamine represented by:

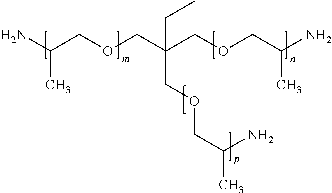

wherein m+n+p is 5-6, or a mixture thereof; the crosslinked polyurea comprises the polyamine crosslinked with 4,4′-dicyclohexylmethane diisocyanate; the epoxy resin comprises a bisphenol-A type epoxy resin and a bisphenol-f type epoxy resin

In certain embodiments, the plurality of the microcapsules and the dispersion matrix are present in a mass ratio of 3:17 to 1:3, respectively.

In certain embodiments, the dispersion matrix further comprises a partially cured epoxy resin formed by reaction of the epoxy resin and the polyamine.

In certain embodiments, 10-30 mol % of the epoxy resin in the dispersion matrix is reacted with the polyamine.

In certain embodiments, the epoxy resin further comprises a polyamine hardener, a polythiol hardener, or a mixture thereof.

In certain embodiments, wherein the plurality of the microcapsules and the dispersion matrix are present in a mass ratio of about 1:4, respectively; and the dispersion matrix further comprises a partially cured epoxy resin formed by reaction of the epoxy resin and the polyamine, wherein the 10-30 mol % of the epoxy resin in the dispersion matrix is reacted with the polyamine.

In certain embodiments, the polyamine comprises TEPA and the polyoxypropylenetriamine, wherein the molar ratio of amines in the TEPA to the polyoxypropylenetriamine is about 3 to about 1, respectively.

In a second embodiment provided herein is a method comprising depositing the one-part adhesive composition described herein to a surface of substrate and curing the one-part adhesive composition thereby forming a cured one-part adhesive composition.

In certain embodiments, the substrate comprises a threaded assembly.

In certain embodiments, curing comprises subjecting the one-part adhesive composition to 25-100° C. for 1-24 hours.

In certain embodiments, curing comprises subjecting the one-part adhesive composition to 35-55° C. for 1-24 hours, 20-25° C. for 1-24 hours, 40-100° C. for 1-24 hours.

In a third aspect provided herein is a cured one-part adhesive composition prepared in accordance with the method described herein.

Building on this advancement, the current work introduces a groundbreaking solvent-free one-part adhesive that incorporates these microencapsulated amines within an epoxy resin, specifically designed as a thread-locking solution. Furthermore, we have developed a method to partially cure the epoxy resin without the use of volatile solvents, achieving an optimal balance between surface dryness and adhesive integrity. This innovative, solvent-free adhesive can be pre-coated to fastening components, such as screws, allowing for extended storage and easy application without the concern of VOC emissions. The characteristics of this adhesive are demonstrated in FIG. 1, which presents the one-part epoxy adhesive as observed under an optical microscope.

The application process is streamlined and efficient: as the screw is tightened, the encapsulated amines are released upon the rupture of their microcapsules, thus initiating the polymerization reaction. This critical process is illustrated in FIG. 2, which provides a cross-sectional view of a hex-head screw treated with our microencapsulated adhesive. The action of tightening the screw facilitates the curing process, obviating the need for separate mixing procedures and enhancing the overall productivity of assembly operations.

### BRIEF DESCRIPTION OF THE DRAWINGS

The foregoing aspects and many of the attendant advantages of this invention will become more readily appreciated and understood by reference to the following detailed description, when taken in conjunction with the accompanying drawings.

FIG. 1 depicts an optical microscope image under white light showing the relatively uniform cured regions of the one-part epoxy adhesive in accordance with certain embodiments described herein.

FIG. 2 depicts a cross-sectional schematic of a hex head screw with microcapsule-based one-part adhesive in accordance with certain embodiments described herein.

FIG. 3 depicts graphs (A-E) showing the dependence of glass transition temperature with concentration of triethylenetetramine (TETA), tetraethylenepentamine (TEPA), a mixture comprising TEPA and Jeffamine® T403 having a 75% and 25% molar ratio of —NH contributed by TEPA and T403, respectively (75TEPA25T403), a mixture comprising TEPA and Jeffamine® T403 having a 50% and 50% molar ratio of —NH contributed by TEPA and T403 (50TEPA50T403), and a mixture comprising TEPA and Jeffamine® T403 having a 25% and 75% molar ratio of —NH contributed by TEPA and (25TEPA75T403), respectively.

FIG. 4 depicts a bar chart showing the break-loose torque results for screws treated with varying types of pure amine/epoxy mixture (composed of 0% microcapsules and 100% liquid amine hardener) in accordance with certain embodiments described herein.

FIG. 5 depicts (A) overview of a PU-75TEPA25T403 microcapsule; (B) cross-section view of the shell; (C) the inner and (D) outer surface of the microcapsule in accordance with certain embodiments described herein.

FIG. 6 depicts a TGA curve of the intact PU-75TEPA25T403 core-shell microcapsules comprising a core comprising 75TEPA25T403 and a shell comprising 75TEPA25T403 crosslinked with 4,4′-dicyclohexylmethane diisocyanate in accordance with certain embodiments described herein.

FIG. 7 depicts a table showing the resting time variation of 75TEPA25T403 amine microcapsule-epoxy (epoxy resin sold under the Epolam 5015 resin tradename) one-part adhesive (composed of 80% microcapsules and 20% hardener) in accordance with certain embodiments described herein at 40° C. according to ISO 9117-5: Drying Tests.

FIG. 8 depicts photographs showing the surface dryness testing of an adhesive screw with 75TEPA25T403 amine microcapsule-epoxy (epoxy resin sold under the Epolam 5015 resin tradename) one-part adhesive (composed of 80% microcapsules and 20% hardener) in accordance with certain embodiments described herein rested at 40° C. for 15 hours.

FIG. 9 depicts a bar chart showing the break-loose torque results for M10 screws treated with 75TEPA25T403 amine microcapsule-epoxy (epoxy resin sold under the Epolam 5015 resin tradename) one-part adhesive (composed of 80% microcapsules and 20% hardener) in accordance with certain embodiments described herein under varying microcapsule sizes and curing temperatures.

FIG. 10 depicts a bar chart showing the break-loose torque results for screws treated with 75TEPA25T403 amine microcapsule-epoxy (epoxy resin sold under the Epolam 5015 resin tradename) one-part adhesive (composed of 80% microcapsules and 20% hardener) in accordance with certain embodiments described herein under varying curing duration and curing temperatures.

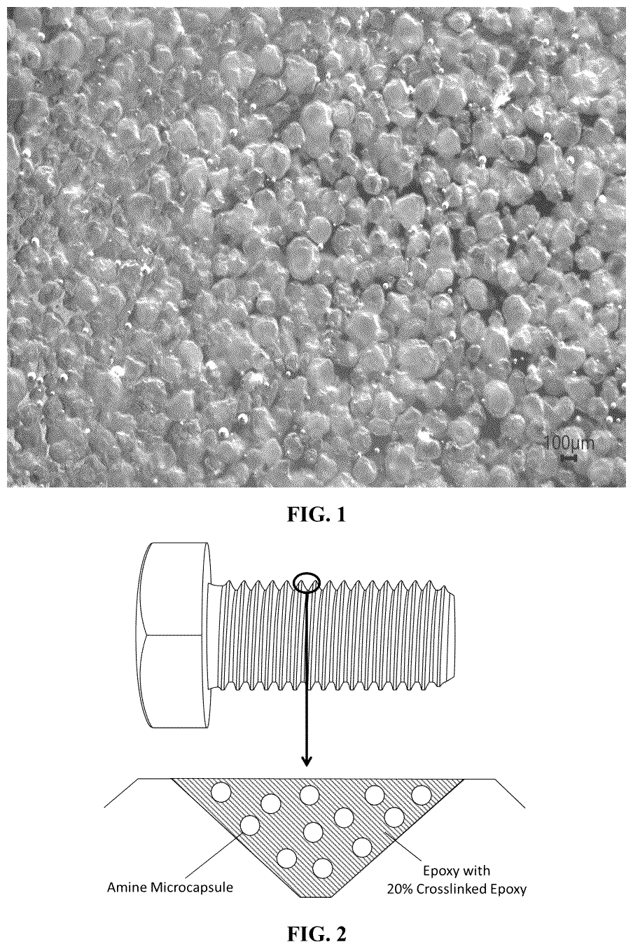

### DETAILED DESCRIPTION

### Definitions

The following terms shall be used to describe the present invention. In the absence of a specific definition set forth herein, the terms used to describe the present invention shall be given their common meaning as understood by those of ordinary skill in the art.

Throughout the application, where compositions are described as having, including, or comprising specific components, or where processes are described as having, including, or comprising specific process steps, it is contemplated that compositions of the present teachings can also consist essentially of, or consist of, the recited components, and that the processes of the present teachings can also consist essentially of, or consist of, the recited process steps.

In the application, where an element or component is said to be included in and/or selected from a list of recited elements or components, it should be understood that the element or component can be any one of the recited elements or components, or the element or component can be selected from a group consisting of two or more of the recited elements or components. Further, it should be understood that elements and/or features of a composition or a method described herein can be combined in a variety of ways without departing from the spirit and scope of the present teachings, whether explicit or implicit herein.

It should be understood that the order of steps or order for performing certain actions is immaterial so long as the present teachings remain operable. Moreover, two or more steps or actions may be conducted simultaneously.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10%, ±7%, ±5%, ±3%, ±1%, or ±0% variation from the nominal value unless otherwise indicated or inferred.

The present disclosure provides a one-part adhesive composition comprising a plurality of microcapsules and a dispersion matrix, wherein each of the plurality of microcapsules comprise a core and a shell at least partially enclosing the core, wherein the core comprises a polyamine and the shell comprises a crosslinked polyurea; and the dispersion matrix comprises an epoxy resin.

In certain embodiments, the one-part adhesive composition does not comprise a solvent.

The polyamine comprises a polyalkylamine, polycycloalkylamine, a polyetheramine, a polyarylamine, or a mixture thereof. The polyamine can comprise at least two, at least three, at least four, or more amines reactive towards epoxy groups per polyamine (e.g., primary amine groups and/or secondary amines groups).

Exemplary polyamines include but are not limited to, 1,2-ethylenediamine, 1,2-propylenediamine, 1,3-propylenediamine, 1,2-butanediamine, 1,3-butanediamine, 1,4-butanediamine, 2,3-butanediamine, 2-methyl-1,3-propanediamine, 2,2-dimethyl 1,3-propanediamine, 1,3-pentanediamine (DAMP), 1,5-pentanediamine, 1,5-diamino-2-methylpentane (MPMD), 1,6-hexanediamine, 2,5-dimethyl 1,6-hexanediamine, 2,2,4- or 2,4,4-trimethylhexamethylene diamine (TMD), 1,7-heptanediamine, 1,8-octanediamine, 1,9-nonandiamine, 1,10-decanediamine, 1-amino-3-aminomethyl-3,5,5-trimethylcyclohexane (isophorone diamine or IPDA), 1,2-diaminocyclohexane, 1,3-diaminocyclohexane, 1,4-diaminocyclohexane, 2- or 4-methyl-1,3-diaminocyclohexane or a mixture thereof, 1,3-bis (aminomethyl) cyclohexane, 1,4 bis(aminomethyl) cyclohexane, 2,5 (2,6)-bis(aminomethyl) bicyclo[2.2.1]-heptane (NBDA), 1,4-diamino-2,2,6-trimethylcyclohexane (TMCDA), 1,8-menthanediamine, 1,3-bis(aminomethyl)benzene (MXDA), 1,4-bis(aminomethyl)benzene, bis (2-aminoethyl)) Ether, 3,6-dioxaoctane-1,8-diamine, 4,7-dioxadecane-1,10-diamine, 4,7-dioxadecane-2,9-diamine, 3-(2-aminoethyl) amino Propylamine, bis(hexamethylene) triamine (BHMT), diethylenetriamine (DETA), triethylenetetramine (TETA), tetraethylenepentamine (TEPA), pentaethylenehexamine (PEHA), dipropylenetriamine (DPTA), N-(2-aminoethyl)-1,3-propanediamine (N3-amine), N,N′-bis(3-aminopropyl)ethylenediamine, N,N′-bis(3-aminopropyl)-1,4-diaminobutane, (3-aminopropyl)-2-methyl-1,5-pentanediamine or N-(3-aminopentyl)-1,3-pentanediamine, Jeffamine® D-230, Jeffamine® D-400, Jeffamine® D-2000, Jeffamine® T-403, Jeffamine® T-3000, Jeffamine® T-5000, or mixtures thereof. In certain embodiments, the polyamine comprises TETA, TEPA, Jeffamine® T-403, or a mixture thereof

Jeffamine® T-403, T-3000, and T-5000 can be represented by the formula:

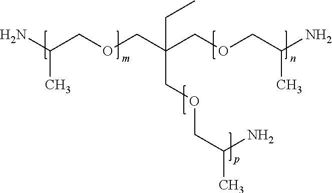

wherein m+n+p is 5.3, 50.3, or 84.8.

Jeffamine® D-230, D-400, and D-2000 can be represented by the formula:

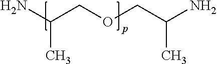

wherein p is 2.5, 5.6, and 33.1, respectively.

In certain embodiments, the polyalkylamine comprises TETA or TEPA and Jeffamine® T-403, wherein the molar ratio of amines in TETA or TEPA and Jeffamine® T-403 is 1:3 to 3:1, 1:3 to 1:1, 1:1 to 3:1, respectively. In certain embodiments, the polyalkylamine comprises TEPA and Jeffamine® T-403, wherein the molar ratio of amines in TEPA and Jeffamine® T-403 is about 3 to about 1, respectively.

The crosslinked polyurea can comprise the polyamine crosslinked with a polyisocyanate. Polyisocyanates useful in the compositions described herein include, but are not limited to, diisocyanates, polyisocyanate biurets of isocyanates and polyisocyanates, isocyanurates of isocyanates and polyisocyanates, and combinations thereof. The polyisocyanate may include a polyisocyanate selected from the group of aromatic polyisocyanates, aliphatic polyisocyanates, and combinations thereof. Exemplary polyisocyanates, include but at not limited to 2,4-toluene diisocyanate (TDI), 2,6-toluene diisocyanate, trimethyl hexamethylene diisocyanate (TMDI), 4,4′-diphenylmethane diisocyanate (MDI), 4,4′-dicyclohexylmethane diisocyanate (H₁₂MDI), 3,3′-dimethyl-4,4′-biphenyl diisocyanate (TODI), dodecane diisocyanate (C₁₂DI), m-tetramethylene xylylene diisocyanate (TMXDI), 1,4-benzene diisocyanate, trans-cyclohexane-1,4-diisocyanate, 1,5-naphthalene diisocyanate (NDI), 1,6-hexamethylene diisocyanate (HDI), 4,6-xylylene diisocyanate, isophorone diisocyanate (IPDI), and combinations thereof. In certain embodiments, the crosslinked polyurea comprises TETA, TEPA, or a mixture comprising TETA or TEPA and Jeffamine® T-403 crosslinked with H₁₂MDI.

Each of the plurality of microcapsules can comprise 70-95 wt %, 75-95 wt %, 80-95 wt %, 85-95 wt %, 90-95 wt %, 70-90 wt %, 70-85 wt %, 70-80 wt %, 70-75 wt %, or 75-85 wt % polyamine relative to the total weight of polyamine and crosslinked polyurea. In certain embodiments, each of the plurality of microcapsules comprises about 80 wt % polyamine relative to the total weight of polyamine and crosslinked polyurea.

The average diameter of the plurality of microcapsules can range from 10-500 μm, 50-500 μm, 100-500 μm, 150-500 μm, 200-500 μm, 250-500 μm, 300-500 μm, 350-500 μm, 400-500 μm, 450-500 μm, 50-450 μm, 50-400 μm, 50-350 μm, 50-300 μm, 50-250 μm, 50-200 μm, 50-150 μm, 50-100 μm, 50-300 μm, 100-300 μm, 150-300 μm, 200-300 μm, 250-300 μm, 50-150 μm, or 75-125 μm. In certain embodiments, the average diameter of the plurality of microcapsules of about 100 μm.

The epoxy resin can be any conventional epoxy resin. Exemplary epoxy resins include, but are not limited to, cresol novolac epoxy resins, phenol novolac epoxy resins, bisphenol A epoxy resins, bisphenol F epoxy resins, bisphenol A-novolac epoxy resins, naphthalene epoxy resins, biphenyl epoxy resins, biphenyl aralkyl epoxy resins, polyacrylate epoxy resin, and combinations thereof. In certain embodiments, the epoxy resin comprises bisphenol A epoxy resins and bisphenol F epoxy resins.

In certain embodiments, the dispersion matrix further comprises a partially cured epoxy resin formed by reaction of the epoxy resin and the polyamine. In certain embodiments, 5-40 mol %, 10-40 mol %, 15-40 mol %, 20-40 mol %, 25-40 mol %, 30-40 mol %, 35-40 mol %, 10-35 mol %, 10-30 mol %, 10-25 mol %, 10-20 mol %, 10-15 mol %, 10-30 mol %, or 15-25 mol % of the epoxy resin is cured by reaction with the polyamine. In certain embodiments, about 20 mol % of the epoxy resin is cured by reaction with the polyamine.

In certain embodiments, the dispersion matrix further comprises one or more of a silica filler, such as fumed silica, a polyamine hardener, or a polythiol hardener.

Exemplary polyamine hardener include, but are not limited to, tetraethylenepentamine (TEPA), polyoxypropylenediamine, diethylenetriamine (DETA), isophorone diamine (IPDA), and 4,4′-methylenedianiline (MDA)

Exemplary polythiol hardeners include, but are not limited to, pentaerythritol tetrakis(3-mercaptopropionate) (PETMP), trimethylolpropane tris(3-mercaptopropionate) (TMPMP), glycol dimercaptoacetate (GDMA), and 1,2-ethanedithiol (EDT)

The present disclosure also provides a method of depositing the one-part adhesive composition described herein to a surface of substrate and curing the one-part adhesive composition thereby forming a cured one-part adhesive composition.

The substrate is not particularly limited, and the present disclosure contemplates all substrates. In certain embodiments, the substrate comprises a metal, a metal alloy, a ceramic, a plastic, wood, concrete, asphalt, drywall, glass, or the like. Additional exemplary substrates include, but are not limited to, low carbon steel, alloy steel, aluminum, and brass. In certain embodiments, the substrate is a threaded screw, a threaded nut, a threaded shaft, or a threaded bolt. In certain embodiments, the threaded assembly is a symmetrical trapezoidal thread, an unsymmetrical trapezoidal thread, a round thread, a rectangular thread, a triangular thread, a tapered thread, a cylindrical thread, a fine thread, a coarse thread, or a normal thread, or a combination thereof.

Curing the one-part adhesive composition can comprise subjecting the one-part adhesive composition to a temperature of 40-100° C., 50-100° C., 60-100° C., 70-100° C., 80-100° C., 90-100° C., 22-80° C., 22-95° C., 40-80° C., 40-95° C., or 80-95° C. The adhesive composition can be subjected to the curing temperature for 1-24 hours, 1-18 hours, 1-12 hours, 1-6 hours, 2-6 hours, 6-24 hours, 12-24 hours, or 18-24 hours.

In certain embodiments, curing the one-part adhesive composition comprises subjecting the one-part adhesive composition to 20-50° C., 30-50° C., or 35-45° C. for 1-24 hours, 12-24 hours, or 12-18 hours; followed by 20-25° C. for 1-24 hours, 6-24 hours, or 6-18 hours; and 22-95° C., 40-95° C. or 80-95° C. for 1-24 hours, 6-24 hours, 12-24 hours, or 18-24 hours. In certain embodiments, curing comprises subjecting the one-part adhesive composition to about 40° C. for about 15 hours; followed by about 22° C. for about 12 hours; and about 80° C. or about 95° C. for about 24 hours.

The present disclosure also provides the cured one-part adhesive composition prepared in accordance with the method described herein. The present disclosure also provides a threaded assembly further comprising the cured one-part adhesive composition prepared in accordance with the method described herein, wherein the cured one-part adhesive composition is disposed on at least one surface of the threaded assembly.

Triethylenetetramine (TETA), tetraethylenepentamine (TEPA), and the polyetheramine sold under the tradename Jeffamine® T403 were selected for demonstration. Prior to conducting mechanical strength testing, it's crucial to establish the stoichiometric ratio between the amine and the epoxy resin. This step ensures the production of fully cured epoxy adhesives. A study was initiated to determine the stoichiometric ratio of amine/epoxy resin for formulations based on TETA, TEPA, and various TEPA/T403 mixtures. By employing differential scanning calorimetry (DSC), we were able to determine the glass transition temperature (T_{g}) of various networks as a function of the amine concentration. At the stoichiometric epoxy/amine ratio, where the degree of crosslinking and chain interactions are at their peak, and segmental motion is at its lowest, we anticipated that the extent of cure T_{g} values would reach their maximum.

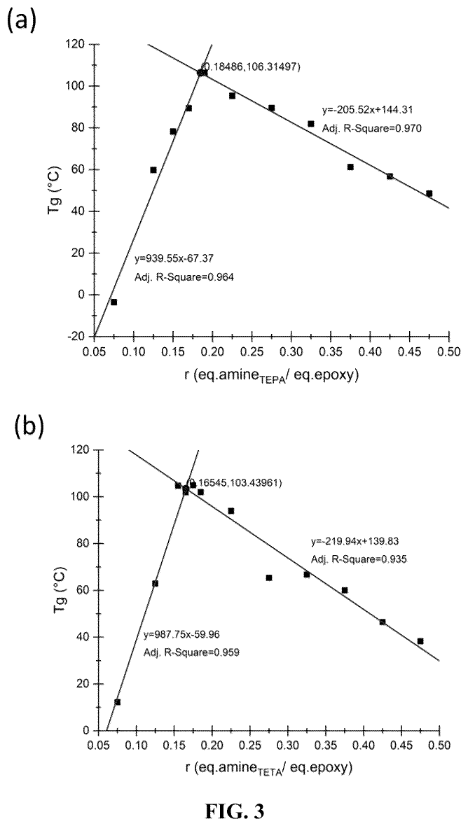

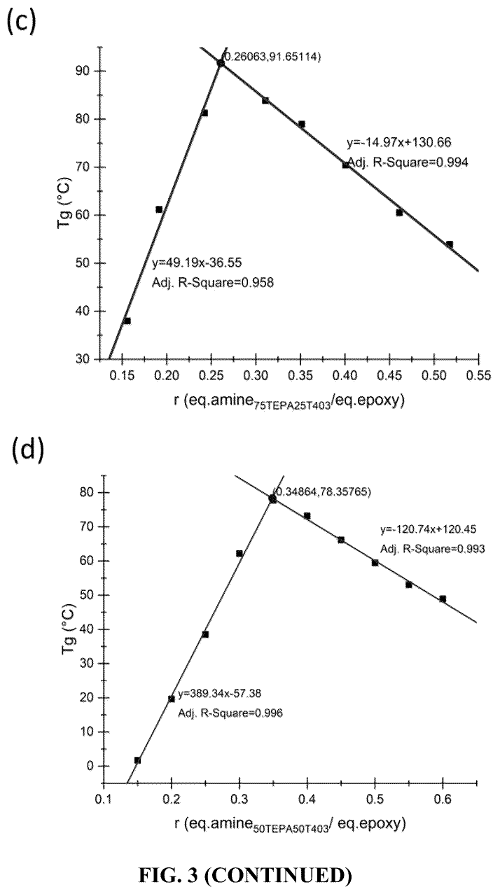

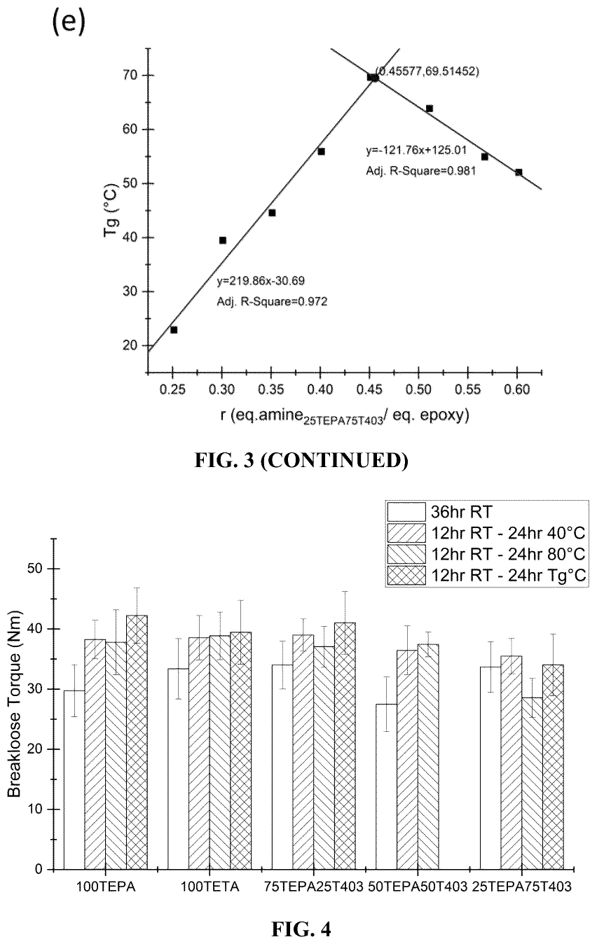

FIG. 3 presents an experimental correlation between T_{g} and amine concentration for different formulations. It's noteworthy that small multifunctional amines such as TEPA and TETA, which have an extremely high amine content, result in a polymer network with high crosslinking density, as evidenced by their high T_{g} values. However, with the addition of the long-chain amine T403, which has a lower amine content, there is a corresponding decrease in T_{g}. This decrease is attributable to a lower crosslinking density, which could potentially contribute to an increase in toughness to a certain degree.

Before progressing to the formulation of the one-part adhesive premised on amine microcapsules, we initially explored the thread-locking performance of two-part amine/epoxy adhesives for preliminary validation. In this experimental setup, the liquid amine hardener and epoxy adhesives were homogeneously mixed, replicating standard operational procedures, immediately prior to their application to the bolt for the adhesion test. Following the application of the liquid admixture, the bolt and nut were assembled, thereby facilitating the wetting and bonding of these two components upon the adhesive's curing.

We tested an array of amine/epoxy combinations, all of which exhibited good bonding performance (as depicted in FIG. 4). To cure the epoxy, we utilized TEPA, TETA, and a variety of TEPA/T403 compositions. These amines inherently contain distinct quantities of reactive groups, resulting in network structures of diverse densities. Typically, in contrast to TEPA and TETA which have high amine content, T403, characterized by its low amine content and extended molecular chain, precipitates an obvious decrease in crosslinking density when added in substantial quantities, thereby compromising the thread-locking performance. Moreover, the diminished reactivity of T403, attributable to its lower polarity, could potentially result in a less time-efficient curing process, which might adversely impact the adhesive's mechanical properties and overall performance.

Temperature is a significant factor influencing the strength of cured products. Consequently, post-assembly of the bolt and nut and after permitting an initial cure at room temperature for 12 hours, we further cured the samples at room temperature, 40° C., 80° C., and at the material's T_{g} (as determined in FIG. 4). Our observations suggest that an increase in curing temperature could potentially augment torque, hinting at a possible correlation between curing temperature and the mechanical efficiency of the adhesive system. The aforementioned results provide an initial demonstration of thread-locking applications with epoxy adhesive, paving the way for further detailed investigations.

Based on the above observations, the efficacy of epoxy adhesives for thread-locking applications has been substantiated. In light of these findings, we selected the amine composition 75TEPA25T403 as the model for further formulation of amine microcapsules-based one-part adhesives for thread-locking applications. This implies that 75% and 25% of the molar ratio of —NH are contributed by TEPA and T403, respectively.

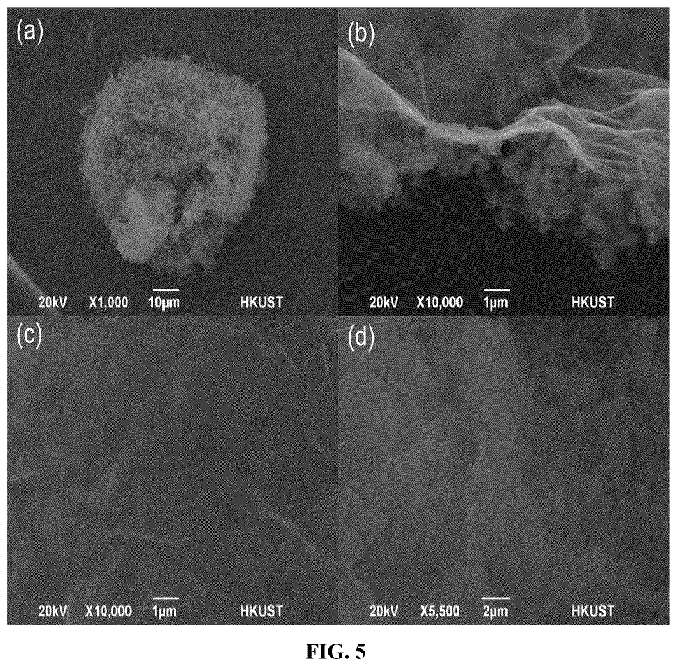

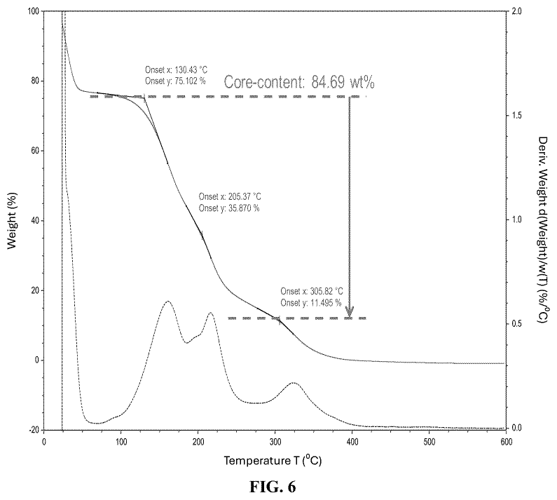

The amine microcapsules are synthesized via an interfacial polymerization method, resulting in polyurea (PU)-shelled amine microcapsules, as depicted in FIG. 5. These microcapsules are characterized by a tightly sealed core-shell structure, which effectively encapsulates the core material, providing a barrier against external environmental factors. The shell's exceptional compactness and stability within the epoxy matrix are instrumental in preventing leakage. The TGA results, presented in FIG. 6, assist in determining the content of core polyamine of the intact microcapsules, which is approximately 85 wt %. The design of the thin yet resilient shell adeptly encloses the core material, striking a balance between protective efficiency and performance. The design of the thin and durable shell adeptly encloses the core material, achieving an equilibrium between protection and performance.

In the absence of a solvent, the addition of a film-forming polymer, critical for pre-applied thread-locking adhesive, was not feasible. Consequently, solvent-free, one-part adhesives for thread-locking application were proposed by incorporating amine-containing microcapsules into the partially cured epoxy resin. The epoxy was partially cured to ensure that the adhesive film could be pre-applied to the screw surface, achieving optimal surface dryness for long-term storage and creating a more user-friendly product for both end-users and manufacturers. With this pre-applied film, upon the tightening of screws, the resultant shearing forces rupture these microcapsules, thereby releasing the enclosed amine curing agents. These agents subsequently react with the epoxy matrix, triggering the polymerization process and bonding the screw-nut surfaces.

In one instance, 20% of the epoxide groups (by the amine mixture 75TEPA25T403, identical to the microcapsule core chemistry) were pre-cured to achieve moderate surface dryness, leaving the remaining 80% to be cured by the amine (75TEPA25T403) microcapsules during adhesion. These amine microcapsules performed a dual role: they functioned as encapsulated agents and served as a dry powder to enhance the viscosity of the epoxy formulation. The resultant increased viscosity restricted the mixture's flow and spread, enabling a thicker, more controlled operation. The inherent rough texture of the amine microcapsules provided an additional advantage, yielding a less tacky surface post-curing and improving the tactile experience for the user.

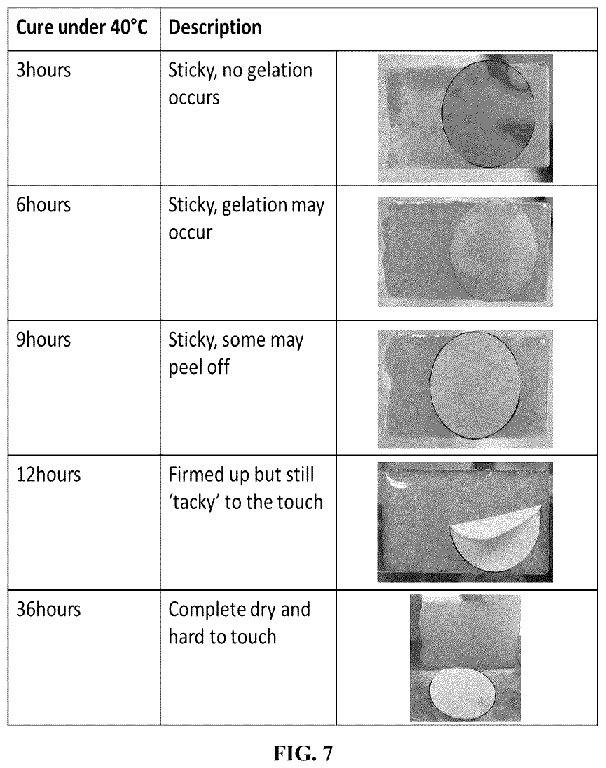

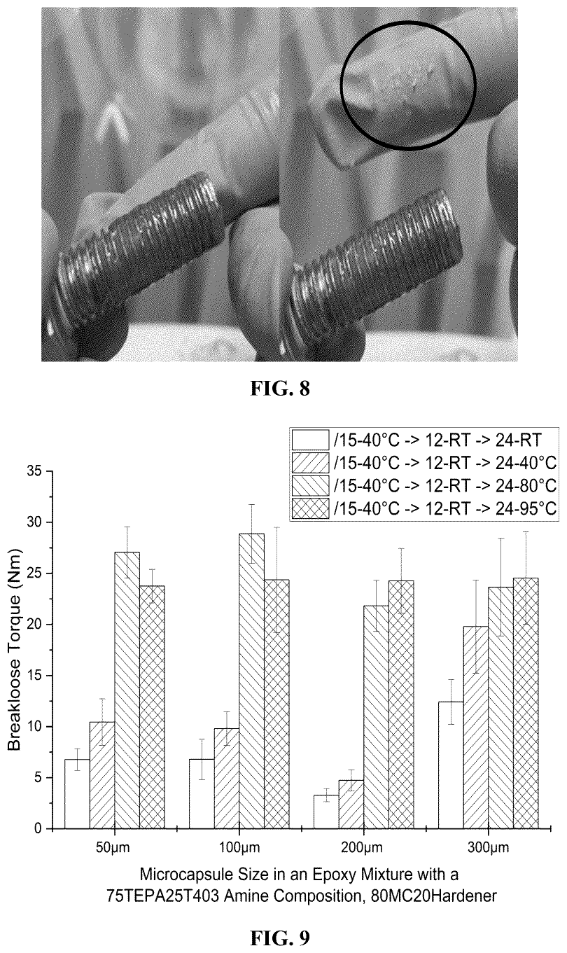

The process involved applying the uncured liquid epoxy mixture on the surface of an M10 hex bolt screw with controlled film thickness, followed by the surface drying process. Temperature and duration emerged as crucial variables influencing the curing and drying process. FIG. 7 demonstrates the drying time variation of the adhesive mixture at 40° C., in accordance with ISO 9117-5. The drying test entailed applying adhesive onto a glass piece, over which a paper piece was placed. A weight of 20 g was subsequently added to the paper. The test piece was then knocked to determine whether the paper could be peeled off. The results revealed that after 9 hours of curing, the sample remained sticky, with the test paper unable to be peeled off. After 12 hours of curing, the sample started to harden but remained ‘tacky’ to touch. After 36 hours of curing, it was completely dry and hard to touch. FIG. 8 presents the surface of the bolt screw after 15 hours of curing with the adhesive mixture. At this stage, the surface is non-tacky, and only some pieces peel off, readying it for further storage or testing.

Upon achieving moderate surface dryness, the products were primed for either long-term storage or immediate application. In the application process, thread bolt screws were inserted into nuts at ambient temperature and left to rest for a duration of 12 hours. It was postulated that during this phase, the microcapsules would rupture, thereby releasing their contents to interact with the epoxy mixture and stimulate additional chain interactions. Subsequent to this resting period, the screws underwent further curing procedures at various temperatures (room temperature, 40° C., 80° C., 95° C.) for an extended period of 24 hours. This procedure was designed to bolster the mechanical properties, dimensional stability, and adhesive characteristics of the epoxy, thereby optimizing its performance and versatility.

The dimensions of the microcapsules hold a significant bearing on the effectiveness of the adhesive. Break-loose torque experiments involving epoxy and microcapsules of diverse sizes were conducted, with the results illustrated in FIG. 9. The microcapsules used in this study varied in size from 50 μm to 300 μm, all demonstrating potential to fracture during the nut-tightening process. The break-loose torque results at different temperatures were as follows: at room temperature, 50 μm yielded 6.78 Nm, 100 μm yielded 6.80 Nm, 200 μm yielded 3.28 Nm, and 300 μm yielded 12.42 Nm. At 40° C., the respective results were 10.43 Nm, 9.80 Nm, 4.74 Nm, and 19.80 Nm. At 80° C., the results were 27.06 Nm, 28.86 Nm, 21.83 Nm, and 23.64 Nm. Meanwhile, at 95° C., the figures were 23.76 Nm, 24.37 Nm, 24.26 Nm, and 24.54 Nm. Notably, microcapsules of 100 μm demonstrated superior performance on average. Larger microcapsules, despite possessing a higher core content, are susceptible to breakage during the screwing process and may not distribute evenly within the epoxy matrix. Conversely, smaller microcapsules can facilitate a more uniform distribution of the amine within the epoxy mixture but are limited by their lower core content and thicker wall, potentially leaving more residual polyurea shell. Importantly, curing temperatures exceeding 80° C. led to substantial improvements. The increased thermal energy at these higher temperatures expedites the curing process and enhances cross-linking in the epoxy resin, thereby improving its mechanical properties and adhesion.

This research focused on refining the resting and curing durations within a specific manufacturing process. The goal was to enhance productivity and expedite the overall process, while still preserving the quality, integrity, and performance of the final product.

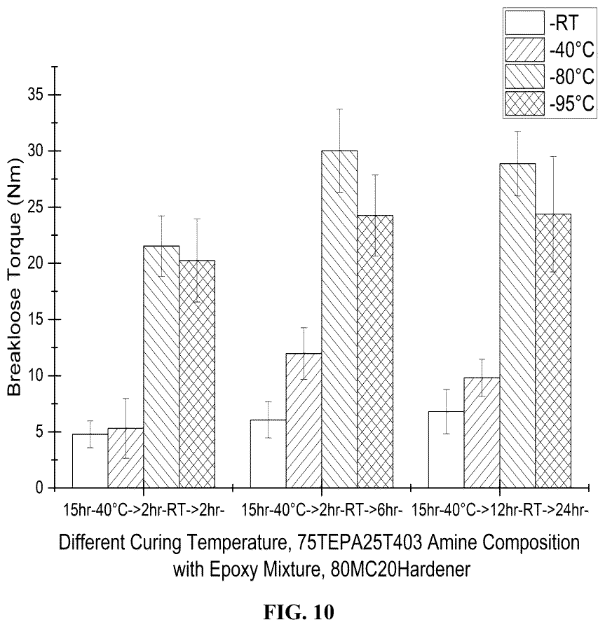

FIG. 10 shows the experimental methodology involved in maintaining a temperature of 40° C. for a period of 15 hours. Alongside this, the resting time was markedly cut from 12 hours to 2 hours, and the curing time was reduced from 24 hours to either 6 or 2 hours. The experimental outcomes revealed that a 2-hour resting period followed by a 2-hour curing period led to diverse torque measurements at varying temperature conditions. The recorded torque values were 4.78 Nm at room temperature (RT), 5.30 Nm at 40° C., 21.54 Nm at 80° C., and 20.24 Nm at 95° C. When the resting period remained at 2 hours and the curing period was extended to 6 hours, the torque values increased: 6.06 Nm at RT, 11.96 Nm at 40° C., 30.02 Nm at 80° C., and 24.25 Nm at 95° C. These results emphasize the potential for performance improvement by strategically reducing the resting and curing periods to 2 hours and 6 hours, respectively. This enhancement was particularly evident during the 80° C. curing process, where the torque achieved with the 80MC20Hardener one-part adhesive (30.02 Nm) closely matched the torque value of the pure hardener two-part adhesive (37.1 Nm).

This evidence suggests not only that process efficiency and output quality can be sustained, but even improved, with considerable reductions in resting and curing times. Furthermore, the comparable performance of a one-part adhesive to a two-part system, particularly when cured at high temperatures, underscores the significant benefits of using one-part adhesives. These include streamlining the production process, reducing the risk of mixing errors, and enhancing production efficiency, especially in high-throughput manufacturing scenarios. The results of this research thus suggest promising avenues for the future utilization of one-part adhesives in a variety of industrial applications.

### Examples

To prepare the amine-containing microcapsules, the TEPA (75 wt %) and Jeffamine® T403 (25 wt %) liquid mixture was injected into the continuous phase, directly via a microfluidic device at room temperature. The outlet of the microtubing was placed beneath the solution surface, next to the periphery of the impeller. At the same time of injection, the continuous phase was stirred with the impeller at 500 rpm. The continuous phase (50.0 g) was composed of paraffin oil dissolved with H₁₂MDI. After injection for 20 min, the system was allowed to react at 40° C. for 6 h. Then the reaction was stopped. The PU-shelled amine microcapsules were washed with n-hexane 5 times and dried in the fume hood for 20 min before collection.

To prepare the solvent free one-part adhesive, 3 g PU-75TEPA25T403, 0.15 g fume silica, 0.6 g 75TEPA25T403 liquid mixture and 10 g EPOLAM 5015 epoxy resin were mixed uniformly. The screw was first cleaned using acetone to eliminate any dirt or potential contaminants that could interfere with the bonding process. The surface of the screw was then coated by immersing it into the mixture. Following this, the samples were kept at room temperature for 12 hours to allow the mixture to cure and reach a state of moderate surface dryness. Subsequently, threaded bolt screws were fastened into nuts at room temperature. The samples were then left at room temperature for a further 12 hours. The curing process was continued at 40° C. for a period of 24 hours, which allows for the thread assemblies sufficiently fastened.

What is claimed is:

1. A one-part adhesive composition comprising a plurality of microcapsules and a dispersion matrix, wherein each of the plurality of microcapsules comprise a core and a shell at least partially enclosing the core, wherein the core comprises a polyamine and the shell comprises a crosslinked polyurea; and the dispersion matrix comprises an epoxy resin.

2. The one-part adhesive composition of claim 1, wherein the plurality of microcapsules have an average diameter of 10-300 μm.

3. The one-part adhesive composition of claim 1, wherein the polyamine comprises a polyalkylamine, a polyetheramine, a polyarylamine, or a mixture thereof.

4. The one-part adhesive composition of claim 1, wherein the polyamine comprises triethylenetetramine (TETA), tetraethylenepentamine (TEPA), a polyoxypropylenetriamine represented by: 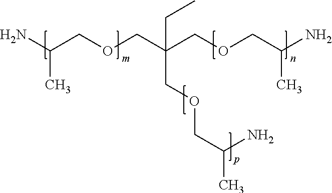
wherein m+n+p is 5-6, or a mixture thereof.

5. The one-part adhesive composition of claim 1, wherein the crosslinked polyurea comprises the polyamine crosslinked with a diisocyanate, a polyisocyanate, or a mixture thereof.

6. The one-part adhesive composition of claim 1, wherein the crosslinked polyurea comprises the polyamine crosslinked with 4,4′-dicyclohexylmethane diisocyanate.

7. The one-part adhesive composition of claim 4, wherein the polyamine comprises TETA, TEPA, or TEPA and the polyoxypropylenetriamine.

8. The one-part adhesive composition of claim 4, wherein the polyamine comprises TEPA and the polyoxypropylenetriamine, wherein the molar ratio of amines in the TEPA to the polyoxypropylenetriamine is 1:3 to 3:1, respectively.

9. The one-part adhesive composition of claim 1, wherein the epoxy resin comprises a bisphenol-A type epoxy resin, a bisphenol-f type epoxy resin, a bisphenol-s epoxy resin, a linear phenolic epoxy resin, a cycloaliphatic epoxy resin, a glycidyl ester type epoxy resin, a glycidyl ether resin, a glycidyl amine epoxy resin, a halogenated epoxy resin, or a mixture thereof.

10. The one-part adhesive composition of claim 1, wherein the epoxy resin comprises a bisphenol-A type epoxy resin and a bisphenol-f type epoxy resin.

11. The one-part adhesive composition of claim 1, wherein the polyamine comprises triethylenetetramine (TETA), tetraethylenepentamine (TEPA), a polyoxypropylenetriamine represented by: 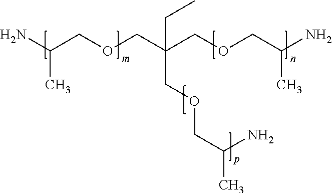
wherein m+n+p is 5-6, or a mixture thereof; the crosslinked polyurea comprises the polyamine crosslinked with 4,4′-dicyclohexylmethane diisocyanate; the epoxy resin comprises a bisphenol-A type epoxy resin and a bisphenol-f type epoxy resin

12. The one-part adhesive composition of claim 11, wherein the plurality of the microcapsules and the dispersion matrix are present in a mass ratio of 3:17 to 1:3, respectively.

13. The one-part adhesive composition of claim 11, wherein the dispersion matrix further comprises a partially cured epoxy resin formed by reaction of the epoxy resin and the polyamine.

14. The one-part adhesive composition of claim 13, wherein 10-30 mol % of the epoxy resin in the dispersion matrix is reacted with the polyamine.

15. The one-part adhesive composition of claim 1, wherein the epoxy resin further comprises a polyamine hardener, a polythiol hardener, or a mixture thereof.

16. The one-part adhesive composition of claim 11, wherein the plurality of the microcapsules and the dispersion matrix are present in a mass ratio of about 1:4, respectively; and the dispersion matrix further comprises a partially cured epoxy resin formed by reaction of the epoxy resin and the polyamine, wherein the 10-30 mol % of the epoxy resin in the dispersion matrix is reacted with the polyamine.

17. The one-part adhesive composition of claim 16, wherein the polyamine comprises TEPA and the polyoxypropylenetriamine, wherein the molar ratio of amines in the TEPA to the polyoxypropylenetriamine is about 3 to about 1, respectively.

18. A method comprising depositing the one-part adhesive composition of claim 1 to a surface of substrate and curing the one-part adhesive composition thereby forming a cured one-part adhesive composition.

19. The method of claim 18, wherein the substrate comprises a threaded assembly.

20. The method of claim 18, wherein curing comprises subjecting the one-part adhesive composition to 25-100° C. for 1-24 hours.

21. The method of claim 18, wherein curing comprises subjecting the one-part adhesive composition to 35-55° C. for 1-24 hours, 20-25° C. for 1-24 hours, 40-100° C. for 1-24 hours.

22. A cured one-part adhesive composition prepared in accordance with the method of claim 18.
